(19) United States
(12) Patent Application Publication
(10) Pub. No.: US 2026/0022014 A1
(43) Pub. Date: Jan. 22, 2026

(54) SYSTEM AND PROCESS FOR CONVERTING LITHIUM HYDROXIDE INTO LITHIUM SULFIDE

(71) Applicants: Matthew James Griffiths, Arlington Heights, IL (US); Neeraj Agrawal, Haryana (IN); Amitkumar Arunkumar Parekh, Maharashtra (IN); Gautham Krishnaiah, Houston, TX (US); Narinder Singh Duggal, Haryana (IN); Kaushik A. Gandhi, League City, TX (US)

(72) Inventors: Matthew James Griffiths, Arlington Heights, IL (US); Neeraj Agrawal, Haryana (IN); Amitkumar Arunkumar Parekh, Maharashtra (IN); Gautham Krishnaiah, Houston, TX (US); Narinder Singh Duggal, Haryana (IN); Kaushik A. Gandhi, League City, TX (US)

(73) Assignee: KELLOGG BROWN & ROOT LLC, Houston, TX (US)

(21) Appl. No.: 19/271,322

(22) Filed: Jul. 16, 2025

Related U.S. Application Data
(60) Provisional application No. 63/673,061, filed on Jul. 18, 2024.

(51) Int. Cl. C01B 17/22; B01J 8/00; B01J 8/18; B01J 8/34

(52) U.S. Cl. CPC C01B 17/22; B01J 8/006; B01J 8/1827; B01J 8/1881; B01J 8/34; B01J 2208/00938; C01P 2006/40; C01P 2006/80

(57) ABSTRACT

A process and system for continuously converting anhydrous LiOH into Li2S by reacting with a sulfur containing gas such as H2S using a fluidized bed reactor with one or more internals. The process may include a solids recovery system to recycle fines and excess sulfur containing gas to the reactor. The process may include a side stripper to strip Li2S product of excess sulfur containing gas and moisture that can be recycled to the fluidized bed reactor.

This application claims the benefit of U.S. Provisional Application No. 63/673,061, filed Jul. 18, 2024, which is incorporated herein by reference in its entirety.

### BACKGROUND OF THE INVENTION

### Field of the Invention

The present invention relates to a system and process for producing lithium sulfide.

### Discussion of the Related Art

There is a recent interest in exploring production of solid-state battery with higher energy density to address the need for solutions to electrification of homes, transportation, and other sectors in line with decarbonizing those sectors with increased electricity generation from renewable resources. Novel materials like lithium sulfide (Li2S) have been targeted as enablers for this development.

A way of producing Li2S involves the conversion of lithium hydroxide (LiOH) to produce Li2S. Currently this process is carried out by a wet process in which hydrogen sulfide (H2S) is reacted with the LiOH in an agitated reactor vessel in the presence of a solvent. This wet process can be carried out at mild temperatures, but it requires additional processing steps for the separation of the final product and recovery of the solvent. This makes the process costly.

Thus, it is desirable to have a more efficient and economical process and system for converting LiOH to produce Li2S.

### SUMMARY OF THE INVENTION

Examples of a system and process for producing lithium sulfide, for example by converting lithium hydroxide into lithium sulfide, can substantially obviate one or more of the problems due to limitations and disadvantages of the related art, or at least to provide the public with a useful alternative.

Examples described herein may provide a process and system to convert LiOH to Li2S using a single reactor process for the direct conversion of LiOH to Li2S utilizing a fluidized bed reactor.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

In examples, provided is a system for producing Li2S that may include a fluidized bed reactor that may include one or more internals, the fluidized bed reactor configured to continuously receive a feed of anhydrous LiOH and contact the feed of anhydrous LiOH with hydrogen sulfide (H2S) to produce lithium sulfide (Li2S).

In examples, the system may include a side stripper coupled to the fluidized bed reactor to receive the Li2S produced in the fluidized bed reactor, the side stripper configured to strip the effluent stream that may include Li2S of moisture, excess H2S, or both. In examples, the side stripper may be configured to strip the effluent stream that may include Li2S at least of excess H2S, and further that may include an H2S recycle stream directing the excess H2S to the fluidized bed reactor.

In examples, the system may include a solids recovery system fluidly connected to or integrated in the fluidized bed reactor. In examples, the solids recovery system may be arranged to receive an overhead stream of the fluidized bed reactor. In examples, the solids recovery system may be configured to separate fines from the overhead stream of the fluidized bed reactor.

In examples, the system may include a fines recycle stream configured to recycle to the fluidized bed reactor the solids separated from the overhead stream of the fluidized bed reactor.

In examples, the fluidized bed reactor may include a dense phase zone and a dilute phase zone.

In examples, an input of the feed of anhydrous LiOH to the fluidized bed reactor is located at, above, or below a bed level of the fluidized bed reactor at a location between the dense phase zone and dilute phase zone.

In examples, the one or more internals may include two or more internals. In examples, the two or more internals may be located in a dense phase zone of the fluidized bed reactor. In examples, the two or more internals may be evenly spaced. In examples, the one or more internals may include angled channels. In examples, the one or more internals may be configured to promote downward flow of solid particles down the fluidized bed reactor. In examples, the one or more internals may be arranged to achieve residence time distribution and a mean residence time for solid particles that yields the Li2S having a purity >95 wt %.

In examples, provided is a method of forming Li2S that may include providing a fluidized bed reactor that may include one or more internals; continuously feeding anhydrous lithium hydroxide (LiOH) to the fluidized bed reactor; continuously feeding a hydrogen sulfide (H2S) gas to the fluidized bed reactor; and contacting the LiOH with the H2S to produce lithium sulfide (Li2S) while flowing the LiOH downward the fluidized bed reactor through the one or more internals.

In examples, the method may include feeding the Li2S to a side stripper fluidly coupled to or integrated in the fluidized bed reactor.

In examples, the method may include stripping excess H2S, moisture, or both from the bottom effluent stream to yield a stripped Li2S product stream and a stripper gas effluent.

In examples, the method may include recycling the dried H2S stripper gas effluent stream to the fluidized bed reactor.

In examples, the method may include filtering an overhead gas stream of the fluidized bed reactor to separate fines from the overhead gas stream to yield a filtered gas stream. In examples, the method may include recycling the fines separated from the overhead gas stream to the fluidized bed reactor. In examples, the method may include recycling the filtered gas stream to the fluidized bed reactor.

In examples, the Li2S produced may include a purity >95 wt %.

Any combination of the above-listed features may be implemented without departing from the spirit or scope of this disclosure. It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates an example of the system and process as described herein.

FIGS. 2A-2B illustrate examples of internals for the system as described herein.

FIG. 3 illustrates an example of the system and process as described herein but with a variation with respect to the recycling of the side stripper overhead stream.

### DETAILED DESCRIPTION

In examples, described herein is a process and system for producing Li2S. In examples, described herein is a process and system for the conversion of LiOH to Li2S. In examples, the process as described is a continuous process. In examples, the system as described is configured to continuously process a feed of anhydrous LiOH converting it to Li2S. In examples, the system as described may include a fluidized bed reactor designed to convert LiOH to Li2S in a continuous manner. In examples, the fluidized bed reactor may be configured to promote a narrow residence time distribution and/or to achieve a substantially uniform residence time distribution for the continuous solid feed in the fluidized bed reactor. In examples, the process and system as described may yield high purity Li2S. In examples, the Li2S output product stream may meet a high purity specification, i.e. >95 wt %, for example, >99.5 wt %. In examples, described herein is a system and process that can be used in commercial operation for the direct conversion of LiOH to Li2S using a fluidized bed reactor.

The term “continuous” as used herein to describe the process or system disclosed herein, refers to a process or system in which feed is continuously supplied to the system and the system continuously outputs a product, recycle, or both. A continuous process or system as described may provide one or more advantages over a batch process. In examples, a continuous process or system as described may reduce or eliminate the need for additional unit operations for the separation and recovery of the solvent thus providing a simpler operation. In examples, the continuous process or system as described may reduce or avoid additional CAPEX for the equipment for separation and recovery of solvent. In examples, a continuous process or system as described may require less energy for the separation and recovery of the solvent. In examples, the process as described herein may yield a product that meets specifications with little to no concern related to trace solvent. In examples, a continuous process or system as described herein may provide any one or more of these and other benefits.

In examples, a system as described herein may include a fluidized bed reactor. In examples, the fluidized bed reactor may include a fluidized bed design with countercurrent flow of solid feeds and a sulfur containing gas. In examples, the solids feed may be converted and discharged from the fluidized bed reactor continuously as a product. In examples, the product may be discharged from a bottom portion of the fluidized bed reactor. In examples, gaseous species including excess sulfur containing gas and/or byproducts can be removed from the top of the fluidized bed reactor. In examples, the system and process as described are designed to maintain adequate solids inventory to ensure the right fluidization regime as well as adequate solids residence time for effecting the desired conversion.

In examples, to meet desired product purity, the fluidized bed reactor design as described and optionally peripheral equipment may be configured to provide the adequate residence time and/or recovery/recycle of solid particles from the gas (e.g., H2S, H2O, N2 etc.) exiting the fluidized bed reactor and/or adequate separation of the gases from the product Li2S.

In examples, the residence time distribution may be uniform or substantially uniform for all solid particles passing through the fluidized bed reactor. In examples, the residence time distribution for all solid particles passing through fluidized bed reactor may be narrow. In examples, the normalized residence time distribution (i.e. ratio of actual residence time to mean residence time) for the solid particles may range from 0.2 to 1.8, for example, 0.4 to 1.6, for example from 0.6 to 1.4, for example from 0.8 to 1.2, for example 1. In examples, the system as described may be configured to reduce the residence time distribution of the solids. In examples, the fluidized bed reactor may include one or more internals. In examples, internals may include any suitable means for staging the fluidized bed, i.e. for reducing back mixing and approaching plug flow. In examples, internals may include baffles, vertical baffles, angled trays, horizontal trays, packing layers, packing such as a fully packed structured system, swages rings, perforated plates, inverse cones, horizontal bars, disc and donut baffles, grating, vertical pipes, vertical compartments, etc. In examples, the one or more internals may be configured to moderate flow of solid particles and gas species. In examples, the one or more internals can be configured to promote uniform directional flow of solid particles, gas species, or both. In examples, the system may be configured such that solid particles move through the fluidized bed reactor in a uniform or mostly uniform direction. In examples, the system and/or fluidized bed reactor and internals may be configured such that solid particles move through the fluidized bed reactor in a down-ward flow direction. In examples, the system is configured such that gas species move through the fluidized bed reactor in a uniform or mostly uniform direction. In examples, the system and/or fluidized bed reactor and internals may be configured such that gas species move through the fluidized bed reactor in an up-ward flow direction.

In examples, a fluidized bed reactor as described may include two or more internals. In examples, a fluidized bed reactor may include a dilute phase section and a dense phase section. In examples, the dense phase section may be provided below the dilute phase section. In examples, one or more internals may be located in the dilute phase section. In examples, one or more internals may be located in the dense phase section. In examples, two or more internals may be present in a given section. In examples, multiple internals located in a section may be evenly spaced.

In examples, the system may include a solids recovery system configured to separate solid fines generated in the fluidized bed reactor from the gas species exiting the top of the fluidized bed reactor. In examples, the solids recovery system may be provided above the fluidized bed reactor. In examples, the solids recovery system may be fluidly connected or coupled to the fluidized bed reactor. In examples, solid fines collected by the solids recovery system may be recycled into the fluidized bed reactor, collected as an intermediate product, and/or purged. In examples, solid fines collected by the solids recovery system may be recycled as additional feed to the fluidized bed reactor. In examples, solid fines collected by the solids recovery system may be sent to a catalyst fines hopper for H2S and/or H2O purging. In examples, solid fines collected by the solids recovery system may be directed to an intermediate product hopper. In examples, the separated gas species may include excess H2S. In examples, the excess H2S may be recycled to the fluidized bed reactor for processing additional LiOH feed. In examples, the separated gas species may be further processed and/or recycled back to the fluidized bed reactor. In examples, moisture may be removed from the gas species prior to recycling the gas species back to the fluidized bed reactor.

A reversible reaction may occur when the LiOH is in the presence of water. Also, the LiOH and Li2S solids are highly hygroscopic and cohesive with a tendency to stick together causing agglomeration or adherence to surfaces of a reactor walls/internals, piping, valves, or other components. Also, H2S may be toxic and thus it may be desirable to remove it from the product. To address one or more of these issues, in examples, the system as described may include a side stripper. In examples, the side stripper may be configured to remove moisture, excess H2S vapors, or both from a Li2S product produced by the fluidized bed reactor. In examples, the side stripper may be coupled to the fluidized bed reactor. In examples, the side stripper may be downstream the fluidized bed reactor so as to receive the produced Li2S produced in the fluidized bed reactor and prior to conveying the Li2S product to one or more product hoppers. In examples, the solid product of Li2S from the fluidized bed reactor bottom may be fed to the side stripper. In examples, by removing the moisture and/or H2S via a side stripper, it may be possible to attenuate or eliminate one or more of the issues moisture and H2S present. In examples, the side stripper may include one or more internals as used for the fluidized bed reactor. In examples, having one or more internals in the stripper may improve solid/gas contacting and removal of gas to be stripped. In examples, additional steps to vent the gases and/or moisture may also be implemented. In examples, additional venting may be provided in the intermittent hoppers downstream of the fluidized bed reactor and/or the side stripper.

Reference will now be made in detail to an embodiment of the present invention, example of which is illustrated in the accompanying drawings.

Unless defined otherwise, all technical and scientific terms used herein have the same meaning as is commonly understood by one of skill in the art to which the inventions belong. All patents, patent applications, published applications and publications, websites and other published materials referred to throughout the entire disclosure herein, unless noted otherwise, are incorporated by reference in their entirety. Where there is a plurality of definitions for terms herein, those in this section prevail. Where reference is made to a URL or other such identifier or address, it is understood that such identifiers can change and information on the internet can come and go, but equivalent information can be found by searching the internet. Reference thereto evidences the availability and public dissemination of such information.

As used herein, the singular forms “a”, “an” and “the” include plural referents unless the context clearly dictates otherwise.

The terms first, second, third, etc. as used herein can describe various elements, components, regions, layers and/or sections, these elements, components, regions, layers and/or sections should not be limited by these terms. These terms may be only used to distinguish one element, component, region, layer or section from another region, layer, or section. Terms such as “first”, “second”, and other numerical terms when used herein do not imply a sequence or order unless clearly indicated by the context. Thus, a first element, component, region, layer, or section discussed below could be termed a second element, component, region, layer, or section without departing from the teachings of the example embodiments.

As used herein, ranges and quantities can be expressed as “about” a particular value or range. “About” also includes the exact amount. Hence “about 5 percent” means about 5 percent in addition to 5 percent. The term “about” means within typical experimental error for the application or purpose intended.

As used herein, “and/or” includes any and all combinations of one or more of the associated listed items.

As used herein, a “combination” refers to any association between two items or among more than two items. The association can be spatial or refer to the use of the two or more items for a common purpose.

As used herein, “comprising” and “comprises” are to be interpreted to mean “including but not limited to” and “includes but not limited to”, respectively.

As used herein, “optional” or “optionally” means that the subsequently described event or circumstance does or does not occur, and that the description includes instances where the event or circumstance occurs and instances where it does not. For example, an optional component in a system means that the component may be present or may not be present in the system.

As used herein, “substantially” means “being largely but not wholly that which is specified.”

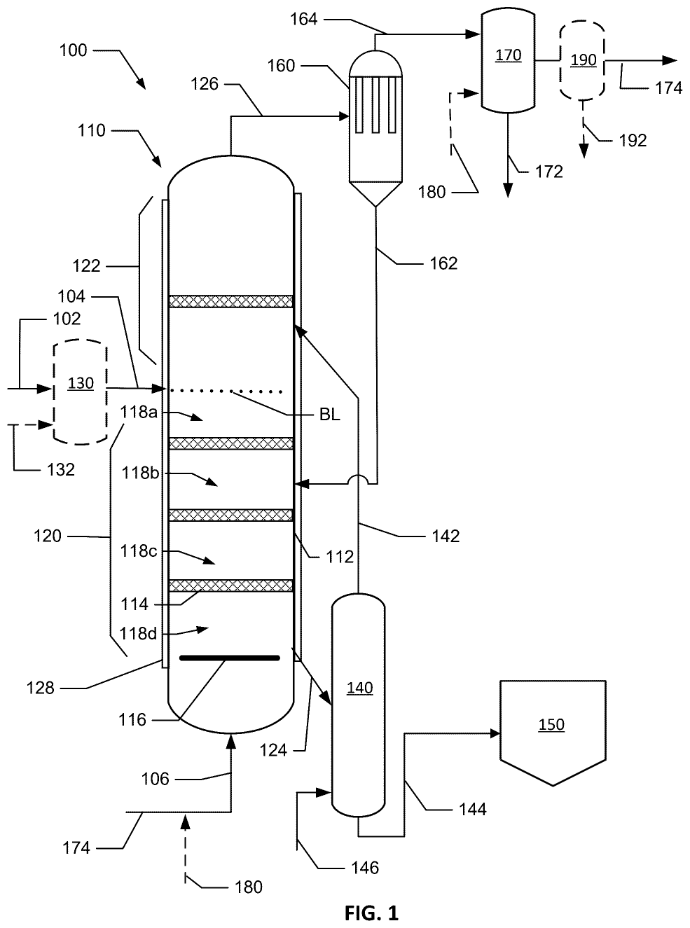

FIG. 1 illustrates an example of system 100 described herein. In examples, a process to produce Li2S may be conducted using system 100 as described herein. In examples, the process is reflected in the herein described operation of system 100. As such, the following description of system 100 reflects a process to produce Li2S within the scope of this description. In examples, the process involves converting LiOH to Li2S using system 100 as described herein. In examples, the LiOH is anhydrous LiOH as described.

In examples, system 100 may include a fluidized bed reactor 110. In examples, system 100 may include an optional input feed drying system including one or more feed drying units 130. In examples, system 100 may include a side stripper 140. In examples, system 100 may include one or more hoppers 150. In examples, system 100 may include a solid recovery system 160. In examples, system 100 may include a gas recycle feed drying system 170. In examples, system 100 may include an optional post drying system 190. In examples, system 100 may include a combination of two or more of components 110, 130, 140, 150, 160, 170, and 190.

In examples, the process and system as described herein can produce high purity Li2S product (>95 wt %, for example, >99.5 wt. % Li2S). In examples, the process and system as described herein can provide a complete conversion of anhydrous LiOH to Li2S. In examples, the process and system as described herein can provide a continuous conversion of anhydrous LiOH to Li2S. In examples, the process and system as described herein can provide a complete and continuous conversion of anhydrous LiOH to high purity Li2S. In examples, the produced Li2S produced by the system and process described herein can exhibit a sufficiently high purity to be a battery grade material.

In examples, the fluidized bed reactor 110 can fluidize a range of particle sizes. In examples, a fluidized bed reactor as described herein can be designed to convert solid LiOH with a mean particle size DP50 of about 10-1500 μm. The Li2S particles used as electrolyte exhibit a particle size in the range of DP50 10-30 μm, thus it can be beneficial to process particle size in this range. However, fluidization of particles with small size may be difficult and handling small size particles of LiOH monohydrate during the drying process may also prove difficult due to the hygroscopic nature of the particles. Accordingly, as an alternative, in examples, the process and system as described herein may convert solid LiOH with a mean particle size DP50 of greater than 30 μm. In examples, the process and system as described herein may convert solid LiOH with a mean particle size DP50 of about 150-800 μm. The product Li2S of larger mean particle size may then be milled in downstream operations to the target size as needed.

In examples, the produced Li2S may then be milled final specifications. In examples, the process and system may include controlling one or more operating conditions and parameters such as temperature, pressure, H2S/LiOH molar ratio, particle size, gas superficial velocity, and fluidization regime, to achieve desired reaction time and conditions and/or high purity of the Li2S product.

In examples, as shown in FIG. 1, fluidized bed reactor 110 may include a reactor vessel 112 including an external wall. In examples, the reactor vessel 112 may be made of any suitable material. In examples, reactor vessel 112 may include a metal or metal alloy. In examples, reactor vessel 112 may include steel and/or other metals. In examples, fluidized bed reactor 110 may be provided in an oblong shape. In examples, a fluidized bed reactor 110 may be provided as a column.

In examples, the fluidized bed reactor 110 may include an anhydrous LiOH feed 104. In examples, LiOH may be fed to a fluidized bed reactor 110 as an anhydrous LiOH feed 104. In examples, the anhydrous LiOH fed to fluidized bed reactor 110 includes solid particles. As used herein, the term “anhydrous LiOH” should be understood to include LiOH having a free water content of less than about 1.0 wt %, for example, less than 0.9 wt %, less than 0.8 wt %, less than 0.7 wt %, less than 0.6 wt %, less than 0.5 wt %, less than 0.4 wt %, less than 0.3 wt %, less than 0.2 wt %, less than 0.1 wt %, or 0 wt %.

In examples, the anhydrous LiOH feed 104 may include one or more contaminant species.

In examples, the anhydrous LiOH feed 104 may include LiOH monohydrate. In examples, feed 104 may include 2.5 wt % LiOH monohydrate or less, for example, 1 wt % or less of LiOH monohydrate. In examples, any LiOH monohydrate present in the anhydrous LiOH feed 104 may also react with the sulfur containing gas to form Li2S.

In examples, a contaminant species may include Li2CO3. In examples, anhydrous LiOH feed 104 may include a mixture of anhydrous LiOH and Li2CO3. In examples, the content of Li2CO3 in anhydrous LiOH feed 104 may be less than 1 wt %. In examples, when Li2CO3 is present in the anhydrous LiOH feed 104, at least a portion of the Li2CO3 may also be converted to Li2S in the system and process described herein. In examples, about 80 wt % or more of the Li2CO3 contained in the anhydrous LiOH feed 104 may be converted to Li2S in the system and process described herein.

In examples, anhydrous LiOH feed 104 is a continuous feed. In other words, in examples, anhydrous LiOH is continuously fed to vessel 112 of the fluidized bed reactor 110. In examples, the feed rate of anhydrous LiOH feed 104 may be controlled to achieve a desired molar ratio with the sulfur containing gas, e.g. H2S. In examples, the rate of anhydrous LiOH feed 104 may thus be controlled in conjunction with the feed rate of the sulfur containing gas, e.g. H2S. In examples, the molar ratio of the sulfur containing gas, e.g. H2S to the anhydrous LiOH may range from about 0.5 to about 20. In examples, the molar ratio of the sulfur containing gas, e.g. H2S to the anhydrous LiOH may range from about 1 to about 5.

In examples, anhydrous LiOH may be provided directly from an outside source. In examples, system 100 may optionally include an input feed drying system to remove water from a feed of LiOH monohydrate. In examples, anhydrous LiOH may be obtained by removing water from LiOH monohydrate. In examples, one or more pretreating steps may be performed to remove water from LiOH monohydrate. In examples, system 100 may include passing a LiOH monohydrate feed 102 through one or more drying units 130 configured to remove water from the LiOH monohydrate and yield an anhydrous LiOH feed 104 to be fed to the fluidized bed reactor 110. Any suitable unit capable of removing water from LiOH monohydrate to yield anhydrous LiOH may be used as a drying unit 130. In examples, a drying unit 130 may include one or more dryers. In examples, a dryer may employ one or more gas species as a drying gas 132. In examples, a drying unit 130 may employ nitrogen (N2) as a drying gas 132. In examples, a drying unit 130 may include a heating system (not shown). In examples, a drying unit heating system may include electrical heating, heat transfer units, burners, a heating jacket, or any combination thereof. In examples, heating in a drying unit heating system may be provided by one or more functional fluids, such as a hot oil. In examples, a drying unit 130 may include one or more hoppers in addition to and/or in place of a dryer. In examples, the pretreatment of LiOH may include passing the LiOH through a drying unit 130 that includes one or more pretreatment hoppers for venting and/or drying of the LiOH. In examples, the resulting anhydrous LiOH may be directed to fluidized bed reactor 110 as anhydrous LiOH feed 104.

In examples, fluidized bed reactor 110 may include a gas feed 106. In examples, gas feed 106 may include sulfur and/or a sulfur containing gas. In examples, gas feed 106 may include H2S gas. In examples, gas feed 106 may include an inert gas. In examples, an inert gas may include nitrogen (N2). In examples, gas feed 106 may include a gas mixture. In examples, gas feed 106 may include a mixture of one or more sulfur containing gases and one or more inert gases. In examples, gas feed 106 may include H2S gas and N2.

In examples, the Li2S may be produced by reacting the anhydrous LiOH with the sulfur containing gas. In examples, where the sulfur containing gas is H2S, the following chemical reaction may take place to produce Li2S:

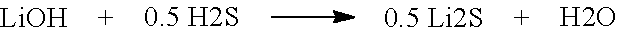

In examples, gas feed 106 may include a recycle gas stream 174. In examples, gas feed 106 may include a make-up gas feed 180. In examples, gas feed 106 may include a mixture of a recycle gas stream 174 and a make-up gas feed 180. As shown in FIG. 1, make-up gas feed 180 is illustrated as a single feed, however, this is just an illustration. Make-up gas feed 180 may include one or more feeds. In examples, make-up gas feed 180 may include a sulfur containing gas, an inert gas, or a combination of both. In examples, make-up gas feed 180 may include a sulfur containing gas feed separate and apart from an inert gas feed. In examples, make-up gas feed 180 may include H2S. In examples, make-up feed may include N2. In examples, make-up gas feed 180 may include an H2S feed separate and apart from an N2 feed. In examples, make-up gas feed 180 may include at least 97 vol % sulfur containing gas, e.g. H2S, for example, from about 98.7 vol % to about 99.5 vol %.

In examples, as shown in FIG. 1, make-up gas feed 180 may be fed into system 100 at one or more locations. In examples, as shown in FIG. 1, make-up gas feed 180 may be combined with a recycle gas stream 174 to form a gas feed 106 just before entering vessel 112 of fluidized bed reactor 110. In examples, not shown, even though gas feed 106 is illustrated as a single feed, make-up gas feed 180 may be inputted into vessel 112 of fluidized bed reactor 110 separate from and independent of the recycle gas stream 174. In examples, make-up gas feed 180 may be combined with filtered gas stream 164 prior to entering a recycle drying unit 170, at gas recycle feed drying system 170, and/or with recycle gas stream 174. In examples, make-up gas feed 180 may be added at multiple stages. For purposes of this description, for examples including a make-up gas feed 180, reference to the gas feed 106 refers to recycle gas feed 174 and the make-up gas feed 180 independent of whether the two feeds are mixed into a single feed or separately fed to vessel 112 of fluidized bed reactor 110.

In examples, as described earlier, gas feed 106 may be fed to vessel 112 of fluidized bed reactor 110 at a rate that may achieve a desired mole ratio between the sulfur containing gas and the anhydrous LiOH. In examples, the gas feed 106 is provided at a rate to achieve a sulfur containing gas, e.g. H2S, to anhydrous LiOH mole ratio in vessel 112 of fluidized bed reactor 110 or at least in the dense phase zone 120 of vessel 112 of fluidized bed reactor 110 of about 0.5 to 20, for example, from about 1 to 5. In examples, the gas feed 106 is fed at a rate to maintain an excess amount of sulfur containing gas, e.g. H2S, with respect to the anhydrous LiOH in vessel 112 of fluidized bed reactor 110 or at least in the dense phase zone 120 of vessel 112 of fluidized bed reactor 110.

In examples, fluidized bed reactor 110 may include a distributor 116. In examples, distributor 116 may include any suitable structure design to distribute the gas fed via gas feed 106. In examples, distributor 116 may include a perforated plate, a sparger, a sintered metal distributor or any combination thereof. In examples, a distributor 116 may improve and/or ensure even distribution of the gas fed via gas feed 106 in vessel 112 of the fluidized bed reactor 110. In examples, even distribution of the gas can provide a more uniform fluidization of the particles inside vessel 112. In examples, distributor 116 may be made of any suitable material. In examples, distributor 116 may include sintered metal or any other suitable material. In examples, distributor 116 may include a corrosion resistance surface, for example, a stainless steel or other corrosion resistant material coating.

In examples, fluidized bed reactor 110 may include one or more heating systems 128. Even though the reaction to produce Li2S may be exothermic in nature, in examples, the fluidized bed reactor 110 may include one or more heating systems 128 to supplement any latent heat to assist with the reduction and/or prevention of condensation of moisture from the water byproduct of the reaction, to overcome heat losses, and/or to maintain a desired operating temperature. In examples, a heating system 128 may provide heat input to maintain the temperature required in the fluidized bed reactor 110 for the conversion of LiOH to Li2S. In examples, a heating system 128 may include any suitable heating system. In examples, a heating system 128 may be internal to the fluidized bed reactor 110, external to the fluidized bed reactor 110, or a combination of both internal and external heating. In examples, the heating system 128 may be configured or arranged to heat the feed before and/or as it enters the fluidized bed reactor 110. In examples, a heating system may include a heater. In examples, a heater may include electrical heater, a heat transfer unit, one or more burners, a heating jacket, heating tubes located inside the fluidized bed reactor 110 that may use a functional fluid such as steam or hot oil, a furnace, immersion heaters in the solids bed to directly provide heat flux required, or any combination thereof. In examples, heating system 128 may include a heating jacket with one or more functional fluids. In examples, a functional fluid may be a hot oil. In examples, the fluidized bed reactor 110 may be operated at a temperature ranging from about 100° C. to about 500° C. In examples, the operating temperature may be 100° C., 120° C., 140° C., 160° C., 180° C., 200° C., 220° C., 240° C., 260° C., 280° C., 300° C., 320° C., 340° C., 360° C., 380° C., 400° C., 420° C., 440° C., 460° C., 480° C., 500° C., or within a temperature range defined by any two of these example temperatures. In examples, the operating pressure of the fluidized bed reactor 110 may range from about 1 Kg/cm² to about 10 Kg/cm², for example 1 Kg/cm², 1.5 Kg/cm², 2 Kg/cm², 2.5 Kg/cm², 3 Kg/cm², 3.5 Kg/cm², 4 Kg/cm², 4.5 Kg/cm², 5 Kg/cm², 5.5 Kg/cm², 6 Kg/cm², 6.5 Kg/cm², 7 Kg/cm², 7.5 Kg/cm², 8 Kg/cm², 8.5 Kg/cm², 9 Kg/cm², 9.5 Kg/cm², 10 Kg/cm², or within a pressure range defined by any two of these example pressures.

In examples, additional heating to the fluidized bed reactor 110 to maintain and/or reach desired operating temperature may be provided by preheating a feed to the fluidized bed reactor 110. In example, gas feed 106 may be heated prior to being fed to the fluidized bed reactor 110. In examples, gas feed 106 including H2S gas and nitrogen may be preheated prior to reaching fluidized bed reactor 110. Any heating system may be used to preheat gas feed 106. In examples, a heating system may include a heater (not shown). In examples, a heater may include any other suitable system for transferring heat to the gas feed. In examples, the heater may include an electrical heater, a heat transfer unit, one or more burners, or any combination thereof.

A continuous fluidized bed reactor may act as a non-ideal continuous stirred-tank reactor (CSTR). As such, the residence time of the solid particles flowing through the fluidized bed reactor may not be uniform. In other words, the residence time for some solid particles may be shorter than the average residence time. This may result in diminished conversion. To address this issue, it may be preferable to cause the solid particles in the fluidized bed reactor to experience a narrower residence time distribution. To achieve this goal may require multiple fluidized bed reactors in series or a very large volume for a single fluidized bed reactor. Both solutions are impracticable. A system with multiple reactor vessels would be very expensive and an extremely large volume single reactor could be unmanageable.

In examples, to ensure more uniform residence time distribution and to achieve the desired conversion rate and purity of Li2S, system 100 may include a fluidized bed reactor 110 that includes one or more internals 114. In examples, the normalized residence time distribution (i.e. ratio of actual residence time to mean residence time) achieved by system 100 may range from 0.2 to 1.8, for example, 0.4 to 1.6, for example from 0.6 to 1.4, for example from 0.8 to 1.2, for example, 1. In examples, the implementation of one or more internals 114 may enable an approach to plug flow reactor (PFR) conditions within a single vessel 112 of the fluidized bed reactor 110. In examples, the one or more internals 114 may improve the solids residence time distribution and decreases the volume required to achieve the desired conversion/product purity. In examples, the implementation of one or more internals 114 allows system 100 to employ a single fluidized bed reactor 110 instead of a series of fluidized bed reactors.

In examples, internals 114 may include any suitable structure. In examples, internals 114 may include baffles, sheds, louvre plates, wire mesh, angled trays, horizontal trays, packing layers, packing such as a fully packed structured system, swages rings, perforated plates, inverse cones, horizontal bars, disc and donut baffles, grating, vertical pipes, vertical compartments, etc.

In examples, the one or more internals 114 may be arranged in vessel 112 of fluidized bed reactor 110 to convert the otherwise single fluidized bed reactor into two or more sequential stages through which the anhydrous LiOH solid particles can travel while contacting the sulfur containing gas, e.g. H2S. In this manner the fluidized bed reactor 110 may be able to act less like a single CSTR, and more like a plug flow reactor (PFR). In examples, this may improve the residence time distribution. In examples, each stage defined by the one or more internals 114 may include a remixing zone 118. In examples, a remixing zone 118 may include a space where anhydrous LiOH solid particles can contact a sulfur containing gas, e.g. H2S. In examples, solid particles may reside a limited amount of time in a remixing zone 118.

In examples, by using the one or more internals 114, the desired conversion and thus product purity may be achieved in a single fluidized bed reactor 110 having a single reactor vessel 112. In examples, this may provide a practical and lower cost solution. In examples, system 100 including one or more internals 114 may provide a solid particles mean residence time ranging from about 0.6 hours (hrs) to about 20 hrs, for example 1 hr to 15 hrs. In examples, the solid particles residence time may be 0.6 hrs, 0.7 hrs, 0.8 hrs, 0.9 hrs, 1 hrs, 2 hrs, 3 hrs, 4 hrs, 5 hrs, 6 hrs, 7 hrs, 8 hrs, 9 hrs, 10 hrs, 11 hrs, 12 hrs, 13 hrs, 14 hrs, 15 hrs, 16 hrs, 17 hrs, 18 hrs, 19 hrs, 20 hrs, or within a range defined by any two of these example times.

In examples, the one or more internals 114 may provide additional benefits besides enabling a plug flow reactor (PFR) like conditions. In examples, the one or more internals 114 may reduce solids back mixing, improve gas/solids contacting, or both.

In examples, an internal may also provide a means to break up bubbles that may be formed and that can be a problem in deep beds with Geldart Group B powders (such as the LiOH particles). In examples, with Geldart Group B particles, large bubbles may form and continue to grow in deep beds. The bubbles may defluidize and/or destabilize the fluidized bed reactor 110. Accordingly, having one or more internals that can also break up any such bubbles may aid in preventing and/or alleviating this problem.

In examples, the fluidized bed reactor 110 may include at least one internal 114. In examples, the fluidized bed reactor 110 may include two or more internals 114. In examples, the fluidized bed reactor 110 may include three or more internals 114. In examples, the maximum number of internals in a fluidized bed reactor 110 may be limited by the size of vessel 112 of fluidized bed reactor 110 and/or by its structural strength. In examples, the maximum number of internals in a fluidized bed reactor 110 may be limited by cost. Thus, any number of internals 114 may be implemented within the structural limits of a given fluidized bed reactor 110. In examples, the fluidized bed reactor 110 may include at least one, two, three, four, five, six, seven, eight, nine, ten, twenty, thirty, forty, fifty, one hundred internals, or any number of internals that falls within the range of any two of these exemplified numbers. In examples, when two or more internals 114 are employed in a zone of the fluidized bed reactor 110, they may be equally spaced. In examples, the fluidized bed reactor 110 may be fully packed at least in the dense phase zone 120, wherein the internal 114 may consist of a contiguous packing that extends inside vessel 112 for the desired length. In examples, the one or more internals 114 are positioned in vessel 112 above distributor 116.

In examples, as illustrated in FIG. 1, the fluidized bed reactor 110 may include a dense phase zone 120 and a dilute phase zone 122. In examples, one or more internals 114 may be provided in each or either dense phase zone 120 and dilute phase zone 122. In examples, as shown in FIG. 1, dense phase zone 120 may include 3 internals 114. In examples, as also shown in FIG. 1, dilute phase zone 122 may include one internal 114. This arrangement is only an example as dense phase zone 120 may include one or more internals 114 and dilute phase zone may have no internals or multiple internals 114. As described earlier, the maximum number of internals 114 that may be provided may be limited by the structural limits of the fluidized bed reactor. In examples, dense phase zone 120 may include any number of internals 114, for example, it may include at least one, two, three, four, five, six, seven, eight, nine, ten, twenty, thirty, forty, fifty, one hundred internals 114, or any number of internals 114 that falls within the range of any two of these exemplified numbers.

In examples, dilute phase zone 120 may include any number of internals 114, for example, it may include no internals or may include at least one, two, three, four, five, six, seven, eight, nine, ten, twenty, thirty, forty, fifty, one hundred internals 114, or any number of internals 114 that falls within the range of any two of these exemplified numbers. In examples, one or more internals 114 in the dilute phase zone 120 may help reduce loss of solids entrained in the gas in the dilute phase 120 and exiting the reactor via overhead stream 126.

In examples, dense phase zone 120 refers to the zone of vessel 112 of fluidized bed reactor 110 in which there is higher presence of solid particles. In examples, the dilute phase zone 122 refers to the zone of vessel 112 of fluidized bed reactor 110 in which there is a lower presence of solid particles. In examples, the bed density in the dense phase zone 120 of vessel 112 of fluidized bed reactor 110 may range from about 200 Kg/m³ to about 650 Kg/m³. In examples, the bed density in the dense phase zone 120 may range from about 350 Kg/m³ to about 600 Kg/m³. In examples, the bed density of the dense phase zone 120 may be 200 Kg/m³, 250 Kg/m³, 300 Kg/m³, 350 Kg/m³, 400 Kg/m³, 450 Kg/m³, 500 Kg/m³, 550 Kg/m³, 600 Kg/m³, 650 Kg/m³, or within a range defined by any two of these examples. In examples, the bed density in the dilute phase zone 122 may be less than that of the dense phase zone 120, for example, less than 200 Kg/m³, less than 150 Kg/m³, less than 100 Kg/m³, or less than 50 Kg/m³, or less than 25 Kg/m³, or less than 10 Kg/m³, or less than 5 Kg/m³, or less than 4 Kg/m³, or less than 3 Kg/m³, or less than 2 Kg/m³, or for example from 1 Kg/m³ to 2 Kg/m³.

In examples, as shown in FIG. 1, the anhydrous LiOH feed 104 may be provided in fluidized bed reactor 110 at, right above, or right below the bed level (BL) of fluidized bed reactor 110. In examples, the anhydrous LiOH feed 104 may be provided at a location between a dense phase zone 120 and a dilute phase zone 122.

In examples, multiple internals 114 provided in a zone may be equally spaced. In examples, by providing equally spaced internals 114, it may be possible to define uniform remixing zones 118 (e.g. 118a, 118b, and 118c). In examples, a remixing zone can include an area where solid particles can remain for a limited time while mixing with a sulfur containing gas, e.g. H2S. In examples, an internal 114 may be configured to radially direct solid particles into a remixing zone 118. In examples, uniform remixing zones 118 may help ensure that the residence time distribution of the solid particles is uniform or substantially uniform. In examples, the residence time for solid particles flowing through fluidized bed reactor 110 may be modified by defining the spacing between internals 114. In examples, the wider the spacing between internals 114, the longer the residence time.

In examples, where the internals 114 includes a contiguous packing structure, the uniform remixing zones 118 may be defined as different sections of the packing structure.

In examples, internals 114 may include any suitable design. In examples, internals 114 may be configured to channel solid particles flowing therethrough to promote unidirectional travel for the solid particles. In examples, internals 114 may be configured to promote a directional flow downward in vessel 112 of fluidized bed reactor 110. In examples, internals 114 may be configured to allow flow of gas therethrough, upward in vessel 112 of fluidized bed reactor 110. In examples, internals 114 may be made of any suitable material. In examples, internals 114 may include stainless steel.

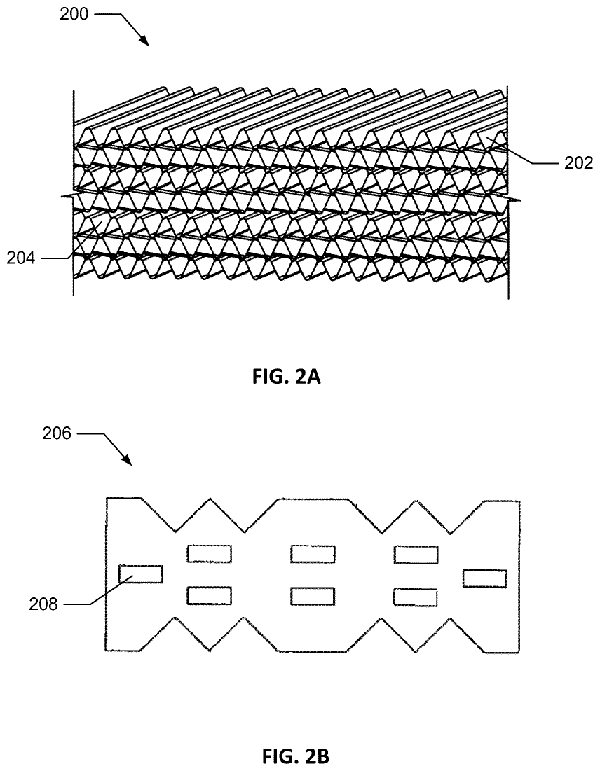

Any suitable structure as previously discussed may be used as internals 114. In examples, internals 114 may include one or more baffles 200 that employ one or more packing elements composed of corrugated lamellas 202, as for example described in U.S. Pat. No. 6,503,460, which is incorporated herein by reference in its entirety. In examples, the corrugations of adjacent lamellas may be oriented in different directions, preferably plus 45 degrees and minus 45 degrees from vertical, as seen in FIG. 2A. In examples, an internal 114 may include channels 204 that may be angled between 45° and 70°. In examples, the channels 204 may be angled at 45°, 50°, 55°, 60°, 65°, 70°, or at any angle that falls within a range defined by any two of these example ranges. In examples, an internal 114 may include an open fraction of 80% of greater, 85% or greater, or 90% or greater, and less than 100%.

In examples, the thickness of an internal may be adjusted as needed to maintain structural integrity. In examples, the thickness of an internal 114 may vary depending on its design and desired performance. In examples, an internal 114 may be a baffle 200 including corrugated lamellas 202 as illustrated in FIG. 2A and may have a thickness of at least about 0.001 cm, for example at least 0.01 cm, for example at least 0.05 cm, for example at least about 0.1 cm, for example at least 0.15 cm, for example at least 0.2 cm, for example at least 0.3 cm, for example at least 0.5 cm, for example at least 1 cm, for example at least 5 cm, for example at least 10 cm, for example at least 15 cm, for example at least 20 cm, for example at least 30 cm, for example at least 40 cm, for example at least 50 cm, for example at least 60 cm. In examples, a greater thickness may help inhibit backflow and/or back mixing.

Another example of a design of an internal 114 may be as described in U.S. Pat. No. 9,238,210, which is incorporated herein by reference in its entirety. In examples, the one or more internals 114 may be oriented at a first angle from about 5° to about 80° as also described in U.S. Pat. No. 9,238,210. In examples, an internal 114 may include a baffle 206 having serrations, protrusions, and/or perforations 208 as for example shown in FIG. 2B. In examples, internals 114 may have curved surfaces. These are only examples as other designs for internals 114 may also be implemented.

In examples, the solid particles of anhydrous LiOH continuously fed from anhydrous LiOH feed 104 can travel downward vessel 112 of fluidized bed reactor 110. As described earlier, in examples, the solid particles pass through the one or more internals 114 and remixing zones 118 as they contact the countercurrent flow of sulfur containing gas provided by gas feed 106. As the anhydrous LiOH travels down the fluidized bed reactor 110, it reacts with the sulfur containing gas species, e.g. H2S, to form Li2S. The Li2S then reaches a bottom portion of vessel 112 of fluidized bed reactor 110. In examples, the Li2S collecting at a bottom portion of fluidized bed reactor 110 is continuously removed from vessel 112 of fluidized bed reactor 110 via bottom effluent stream 124.

In examples, the sulfur containing gas provided to the fluidized bed reactor 110 via gas feed 106 and dispersed via distributor 116 travels upward in vessel 112, in a countercurrent flow to the solid particles of LiOH. In examples, in vessel 112 of the fluidized bed reactor 100, the sulfur containing gas, e.g. H2S, may contact the solid particles of anhydrous LiOH and reacts with the anhydrous LiOH to form solid particles of Li2S and a residual gas, e.g. water (H2O) when the sulfur containing gas is H2S. In examples, the temperature inside the vessel 112 of the fluidized bed reactor 110 may be sufficiently high that the residual gas, e.g. water, may be in vapor phase. In examples, by maintaining the moisture inside the vessel 112 in vapor phase, it may be possible to promote its rise upward in vessel 112 of fluidized bed reactor 110 along with any excess, unreacted sulfur containing gas, e.g. H2S, and any other fluidizing gas such as inert gas, e.g. N2. This can help remove the moisture from vessel 112 of the fluidized bed reactor. The mixture of moisture, i.e. H2O, excess sulfur containing gas, e.g. H2S, and inert gas, e.g., N2 reach the top of vessel 112 of fluidized bed reactor 110 and may be continuously ejected from fluidized bed reactor 110 via overhead stream 126.

### Solids Recovery System and Process

In examples, the production of Li2S in the fluidized bed reactor 110 may also result in the formation of fines. In examples, at least a portion of the fines may travel with the gas species upward vessel 112. In examples, any fines generated in the process may be separated from the gas species and returned to the reactor.

In examples, system 100 may include a solids recovery system 160 configured to separate, and optionally collect, the solids or fines generated in the fluidized bed reactor 110. In examples, solids recovery system 160 may be fluidly connected or coupled to vessel 112 and/or fluidized bed reactor 110. In examples, the solids recovery system 160 may be integrated with the fluidized bed reactor 110. In examples, the top portion of vessel 112 above dilute phase zone 122 the of fluidized bed reactor 110 may be extended to house a solids recovery system 160 as described herein.

In examples, as illustrated in FIG. 1, the solids recovery system 160 may be provided to receive the overhead stream 126 of fluidized bed reactor 110. In examples, the solids recovery system 160 may separate overhead stream 126 into a fines recycle stream 162 and a filtered gas stream 164.

In examples, when excessive fines are produced, system 100 may include a fluidized bed reactor 110 configured to include a continuous return of fines back to the reactor to maintain reactor solids inventory and adequate residence time in the reactor to achieve full conversion of LiOH particles to Li2S.

In examples, solid fines collected by the solids recovery system may sent to a catalyst fines hopper for H2S and/or H2O purging. In examples, solid fines collected by the solids recovery system may be directed to an intermediate product hopper.

In examples, the overhead stream 126 of fluidized bed reactor 110 or, if the solids recovery system 160 is integrated inside the fluidized bed reactor 110 an overhead of dilute phase zone 122, is introduced to solids recovery system 160. In examples, any suitable separation system may be utilized for solids recovery system 160. In examples, solids recovery system 160 may include a continuous filtration system. In examples, solids recovery system 160 may include a cyclone filter, centrifugal separators, or any like filtration system.

In examples, the solids or fines separated from the gas species by solids recovery system 160 may be recycled or returned to vessel 112 of fluidized bed reactor 110 via fines recycle stream 162. In examples, the fines separated in solids recovery system 160 are continuously recycled or returned to vessel 112 of fluidized bed reactor 110 via fines recycle stream 162.

In examples, the filtered gas stream 164 from by solids recovery system 160 may also be recycled to fluidized bed reactor 110. In examples, the filtered gas stream 164 may include unreacted sulfur containing gas, inert fluidization gas, moisture, or any combination thereof. In examples, the filtered gas stream 164 may include unreacted H2S, inert gas N2, and water vapor. In examples, it may be desirable to remove the water vapor or moisture for the filtered gas stream 164 prior to recycling the stream to the fluidized bed reactor 110. A reversible reaction may occur when the LiOH is in the presence of water. Also, the LiOH and Li2S solid particles are highly hygroscopic and cohesive with a tendency to stick together causing agglomeration or adherence to surfaces of a reactor walls/internals, piping, and valves. In examples, by removing the moisture, it may be possible to attenuate or eliminate one or more of these issues. In examples, the moisture may be removed from filtered gas stream 164 prior to recycling the stream to the fluidized bed reactor 110.

In examples, system 100 may include a gas recycle feed drying system 170. In examples, gas recycle feed drying system 170 may include one or more drying units. In examples, gas recycle feed drying system 170 may include a dryer or other water removal system. In examples, a dryer may employ one or more gas species as a drying gas. In examples, a gas recycle feed drying system 170 may employ cooling (to condense) followed by a knock-out vessel/drum, solids desiccant dehydration (adsorption drying) or any other suitable way to dry gas.

In examples, filtered gas stream 164 is passed through gas recycle feed drying system 170 to remove at least a portion of the moisture contained therein. In examples, the water removed may be dispensed at stream 172 for further processing or disposal. The dried filtered gas stream from the gas recycled feed drying system 170 forms gas recycle stream 174 that may be recycled to fluidized bed reactor 110 as gas feed 106. In examples, the gas recycle stream 174 may contain less than about 100 wtppm water, for example, less than about 50 wtppm water, or less than about 10 wtppm water. In examples, the gas recycle stream 174 may be continuously recycled to fluidized bed reactor 110 as gas feed 106.

As illustrated in FIG. 1, and as described earlier, a make-up gas stream 180 of sulfur containing gas and/or fluidization inert gas may be added as needed by combining it either to filtered gas stream 164, at gas recycle feed drying system 170, or to gas recycle stream 174 after the drying process.

In examples, system 100 may include an optional post drying system 190. In examples, post drying system 190 may include a compression system, such as a gas compressor. Any suitable compression system may be used. In examples, system 190 may include a CO2 removal unit, such as a unit including a zeolite adsorbent specifically designed to remove CO2. Any suitable CO2 removal system may be used. In examples, post drying system 190 may include a combined system configured for CO2 removal and for gas compression. In examples, CO2 may be formed from the conversion of contaminant Li2CO3 to Li2S. In examples, post drying system 190 may be configured to selectively remove CO2 via outflow 192 from the gas recycle stream 174 formed at gas recycled feed drying system 170. In examples, removal of CO2 may improve excessive gas waste. In examples, CO2 removal unit may be configured to avoid and/or minimize removal of H2S from gas recycle stream. In examples, gas recycle stream 174 post CO2 removal may contain less than 500 wtppm, for example, about 20 to about 100 wtppm. Maintaining a low CO2 content in the gas recycle stream 174 may help in preventing the conversion of anhydrous LiOH to Li2CO3 in the fluidized bed reactor 110. In examples, the post drying system 190 may compress the gas recycle stream 174 from gas recycled feed drying system 170 to reactor pressure, optionally, after CO2 removal.

### Side Stripper and Process

In examples, the Li2S produced in fluidized bed reactor 110 may be continuously discharged from a bottom portion of vessel 112 of the fluidized bed reactor 110 via bottom effluent stream 124. In examples, the Li2S bottom effluent stream 124 may be directed to one or more hopper drums 150 and then milled, if necessary for use as electrolyte or other means. In examples, bottom effluent stream 124 may contain moisture and/or excess sulfur containing gas, e.g. H2S, in addition to the Li2S. In examples, it may be beneficial to separate the sulfur containing gas from the Li2S product so that it may be recycled to fluidized bed reactor 110.

In examples, system 100 may include a side stripper 140. Li2S solids can be highly hygroscopic and cohesive with a tendency to stick together causing agglomeration or adherence to surfaces of a reactor walls/internals, piping, and valves. Also, H2S may be toxic and thus it may be desirable to remove it from the product. In examples, by removing the moisture and H2S via a side stripper 140, it may be possible to attenuate or eliminate one or more of these issues. In examples, additional steps to vent the gases may also be implemented. In examples, additional venting may be provided in one or more intermittent hoppers 150 downstream of the fluidized bed reactor 110.

In examples, the side stripper 140 may be configured to strip or remove moisture, hazardous sulfur containing gas vapors, e.g. excess H2S and/or other H2S vapors, or both prior to conveying the Li2S product to one or more product hopper drums 150. In examples, the side stripper 140 may be fluidly coupled to vessel 112 and/or the fluidized bed reactor 110. In examples, the solid product from the fluidized bed reactor 110 bottom may be fed to the side stripper 140. In examples, the side stripper 140 may be configured to remove a majority (e.g., greater than 50 wt %, for example, greater than 80 wt %) of the moisture, a majority (e.g., greater than 50 wt %, for example, greater than 80 wt %) of hazardous sulfur containing gas vapors, e.g. excess H2S and/or other H2S vapors, or both from the Li2S produced in fluidized bed reactor 110 that is discharged via bottom effluent stream 124.

In examples, side stripper 140 may include any suitable stripper design. In examples, nitrogen gas N2 may be used as the stripping agent. In examples, side stripper 140 may include a N2 feed 146. In examples, the N2 in N2 feed 146 may be heated prior to entering side stripper 140. In examples, the side stripper 140 may include one or more internals (not shown). In examples, the same or similar internals used in the fluidized bed reactor may be used for side stripper 140. In examples, having one or more internals in the stripper may improve solid/gas contacting and removal of gas to be stripped. In examples, one or more internals in side stripper 140 may be arranged in any suitable manner. In examples, the one or more internals in side stripper 140 may be arranged to achieve improved stripping effects.

In examples (not shown), the side stripper 140 may be internal to fluidized bed reactor 110. In examples, the side stripper 140 may be provided inside vessel 112 of the fluidized bed reactor 110, above or below the distributor 116. In examples, the side stripper 140 may be provided inside with vessel 112 of the fluidized bed reactor 110, at least in part in dense phase zone 120. In examples, where the side stripper 140 is internal to fluidized bed reactor 110, the stripper overhead gas effluent 142 may be reintroduced in the dense phase zone 120 and/or may be directed to an upper portion or the dilute phase zone of vessel 112 of fluidized bed reactor 110 as described for a side stripper 140 that is not internal to the fluidized bed reactor 110.

In examples, the side stripper bottom effluent 144 may include a stream of stripped Li2S. In examples, the stripper overhead gas effluent 142 may include the sulfur containing species, water vapor or moisture, and N2. In examples, the side stripper bottom effluent 144 may be directed to one or more product hopper drums 150 for further processing. In examples, the stripper overhead gas effluent 142 may be recycled to fluidized bed reactor 110. In an example, as illustrated in FIG. 1, the stripper overhead gas effluent 142 may be directed to an upper portion or the dilute phase zone of vessel 112 of fluidized bed reactor 110. In this manner it may be possible to minimize the reaction between the gas species contained in stripper overhead gas effluent 142 and anhydrous LiOH fed to fluidized bed reactor 110. In examples, by directing the stripper overhead gas effluent 142 to an upper portion or the dilute phase zone of vessel 112 of fluidized bed reactor 110 it may be possible to better ensure that the gas species contained in the stripper overhead gas effluent 142 outflow from fluidized bed reactor 110 from overhead stream 126 and become part of the gas recycle stream 164.

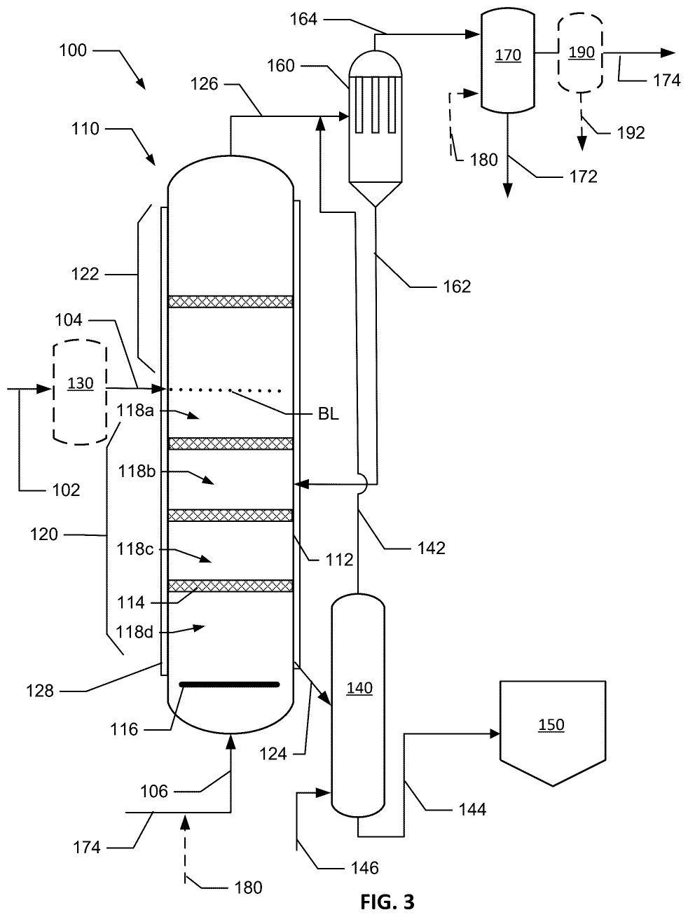

In examples, as illustrated in FIG. 3, the stripper overhead gas effluent 142 may be mixed with overhead stream 126 of fluidized bed reactor 110 ahead of solids recovery system 160. In examples, any combination of the two arrangements of FIGS. 1, and 3 with respect to recycling stripper overhead gas effluent 142 may be implemented.

### Process

In examples, a process using system 100 as described with reference to FIGS. 1-3 may be implemented. In examples, the process reflects the functioning of system 100 as previously described with reference to FIGS. 1-3. In examples, the process may include feeding anhydrous LiOH solid particles to a fluidized bed reactor 110. In examples, the anhydrous LiOH may be sourced directly or optionally may be derived from a LiOH monohydrate feed that is passed through input feed drying system that include one or more drying units 130. In examples, the anhydrous LiOH is fed to the fluidized bed reactor 110 on a continuous basis. In examples, the anhydrous LiOH may enter the fluidized bed reactor 110 at the top or upper portion thereof. In examples, the anhydrous LiOH enters the fluidized bed reactor 110 at, just above, or just below the bed level (BL) of fluidized bed reactor 110, at a location between a dense phase zone 120 and a dilute phase zone 122.

In examples, a gas feed 106 containing mainly a sulfur containing gas, such as H2S, and an inert gas, such as N2, may enter the fluidized bed reactor 110 at a bottom portion thereof. In examples, the gas feed 106 is continuously provided to fluidized bed reactor 110. In examples, the gas feed 106 may be provided to the fluidized bed reactor 110 through a distributor 116. In examples, distributor 116 may be configured to provide uniform gas distribution and effective contacting of anhydrous LiOH solid particles with gas.

In examples, the fluidized bed reactor 110 includes one or more internals 114. In examples, the anhydrous LiOH travels downward the fluidized bed reactor passing through the one or more internals 114. In examples, the solid particles traveling through the fluidized bed reactor may be channeled by the one or more internals 114 to maintain a downward motion. In examples, the one or more internals 114 may be configured to promote flow of solid particles downward in the fluidized bed reactor. In examples, the gas species from gas feed 106 travel upward through the fluidized bed reactor passing through the one or more internals. In examples, the one or more internals 114 may be configured to promote flow of gas species from gas feed 106 upward the fluidized bed reactor. In examples, the H2S in gas feed 106 comes into contact and can react with the anhydrous LiOH to produce Li2S and H2O.

In examples, the gas species from gas feed 106 may provide the fluidization of solid particles inside the reactor and achieve desired gas superficial velocity in the reactor. In examples, the gas superficial velocity in the reactor may be about minimum fluidization velocity to 3 m/s, for example, 0.2 to 1.2 m/s. In examples, the gas superficial velocity may be 0.0004 m/s, 0.001 m/s, 0.005 m/s, 0.01 m/s, 0.05 m/s, 0.1 m/s, 0.15 m/s, 0.2 m/s, 0.3 m/s, 0.4 m/s, 0.5 m/s, 0.6 m/s 0.7 m/s, 0.8 m/s, 0.9 m/s, 1 m/s, 1.2 m/s, 1.4 m/s, 1.6 m/s, 1.8 m/s, 2 m/s, 2.2 m/s, 2.4 m/s, 2.6 m/s, 2.8 m/s, 3 m/s, or within a range defined by any two of these examples. In examples, the fluidization regime in fluidized bed reactor 110 may be minimum to fast fluidization, for example, slugging to turbulent fluidization. In examples, the system and process as described herein may be used to achieve a mean residence time and/or a uniform or mostly uniform residence time distribution for the solid particles passing through the fluidized bed reactor 110 to achieve a high purity product (>95 wt %, for example, >99.5 wt. %). In examples, as described earlier, the mean residence time of solids particles in the fluidized bed reactor 110 can be from about 0.6 hrs to about 20 hrs, for example, from 1 hr to about 15 hrs.

In examples, the excess sulfur containing gas and moisture formed in the fluidized bed reactor 110 may leave the fluidized bed reactor 110 via overhead stream 126. In examples, the overhead stream 126 may be directed to a solid recovery system 160 to separate at least a portion of the fines trapped in the overhead stream 126. In examples, the separated fines from solids recovery system 160 may be recycled to the fluidized bed reactor 110. In examples, the filtered gas stream 164 may be provided to a gas recycle feed drying system 170 to remove at least some of the moisture and yield a recycle gas stream 174. The recycle gas stream 174 may be recycled to the fluidized bed reactor as gas feed 106. In examples, a make-up stream 180 including a sulfur containing gas and/or inert gas may be added to gas feed 106, filtered gas stream 164, gas recycle feed drying system 170, recycle gas stream 174, separately provided to fluidized bed reactor 110, or any combination thereof.

In examples, a stream containing the Li2S produced in the fluidized bed reactor 110 may exit the fluidized bed reactor 110 at a bottom portion thereof. In examples, the bottom stream containing the Li2S product may be directed to a side stripper to separate at least a portion of excess sulfur containing gas, e.g. H2S, and/or moisture from the Li2S product stream. The stripped Li2S product stream may then be directed to one or more product hopper drums 150 for further processing and use. In examples, the sulfur containing gas, e.g. H2S, and/or moisture stripped form the Li2S product stream may be recycled to the fluidized bed reactor 110 either directly or indirectly. In examples, at least some moisture may be removed from the stream of sulfur containing gas, e.g. H2S, and/or moisture stripped form the Li2S product stream prior to recycling to the fluidized bed reactor.

In examples, the system described herein including the fluidized bed reactor, solids recovery system, side stripper, drying system, one or more hoppers downstream the fluidized bed reactor along with any other process equipment related thereto may include one or more control systems, sensors, and other standard components that allows for the control and operation thereof.

In examples, although not shown, the systems described herein may include one or more sensors as generally employed in the art. In examples, sensors may be used to monitor the operation of the systems described. Non-limiting examples of one or more sensors may include temperature sensors, pressure sensors, flow meters, gas composition analyzers, and other like sensors.

In examples, although not shown, the one or more control systems may include one or more controllers and/or other suitable computing devices may be employed to control one or more of portions of system described herein. The controls systems may include any number of logical, programmatic, and physical components. In examples, controllers may include one or more processors and memory communicatively coupled with each other. In examples, one or more input/output devices such as monitors, keyboards, speakers, microphones, computer mouse and the like may be coupled to the one or more controllers. In examples, the one or more controllers may include one or more communication elements such as receivers, transmitters, transceivers or like structure to enable wired and/or wireless communication.

In examples, memory associated with the one or more controllers and/or other suitable computing devices may be non-transitory computer-readable media. Any suitable memory technology may be employed to implement a memory, for example, static random-access memory (SRAM), synchronous dynamic RAM (SDRAM), nonvolatile/Flash-type memory, or any other type of memory capable of storing information.

In examples, a memory may be used to store logic instructions including, without limitation, one or more software modules and/or other sufficient information for operation, safety procedures, and/or routine maintenance processes. In examples, logic instructions may be employed to operate, control, and/or monitor the operation of the system and/or one or more subcomponents thereof. In examples, the memory may store an operating system and one or more software applications, instructions, programs, and/or data to implement the methods described herein and the functions attributed to the various systems. Any operation of the described system may be implemented in hardware, software, or a combination thereof. In the context of software, operations represent computer-executable instructions stored on one or more computer-readable storage media that, when executed by one or more processors, perform the recited operations. Computer-executable instructions may include programs, objects, routines, data structures, components, and the like that perform one or more functions or implement particular abstract data types.

In examples, the system and process as described herein may provide one or more advantages over known wet chemistry processes that are used in the industry. In examples, the system and process may avoid additional unit operations for the separation and recovery of the solvent would be avoided with a simpler operation. In examples, the system and process as described herein may avoid additional capital cost for the equipment for separation and recovery of solvent of a wet chemistry process. In examples, the system and process as described herein may require less energy consumption by not requiring separation and recovery of a solvent that is necessary in a wet chemistry process. In examples, the system and process as described herein may meet specification of final product without concern related to trace solvent as is the case in a wet chemistry process.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A system for producing Li2S comprising:
a fluidized bed reactor comprising one or more internals, the fluidized bed reactor configured to continuously receive a feed of anhydrous LiOH and contact the feed of anhydrous LiOH with hydrogen sulfide (H2S) to produce lithium sulfide (Li2S).

2. The system of claim 1, further comprising a side stripper coupled to the fluidized bed reactor to receive the Li2S produced in the fluidized bed reactor, the side stripper configured to strip the effluent stream comprising Li2S of moisture, excess H2S, or both.

3. The system of claim 2, wherein the side stripper is configured to strip the effluent stream comprising Li2S at least of excess H2S, and further comprising an H2S recycle stream directing the excess H2S to the fluidized bed reactor.

4. The system of claim 1, further comprising a solids recovery system fluidly connected to or integrated in the fluidized bed reactor.

5. The system of claim 4, wherein the solids recovery system is arranged to receive an overhead stream of the fluidized bed reactor.

6. The system of claim 5, wherein the solids recovery system is configured to separate fines from the overhead stream of the fluidized bed reactor.

7. The system of claim 6, further comprising a fines recycle stream configured to recycle to the fluidized bed reactor the solids separated from the overhead stream of the fluidized bed reactor.

8. The system of claim 1, wherein the fluidized bed reactor comprises a dense phase zone and a dilute phase zone.

9. The system of claim 8, wherein an input of the feed of anhydrous LiOH to the fluidized bed reactor is located at, above, or below a bed level of the fluidized bed reactor at a location between the dense phase zone and dilute phase zone.

10. The system of claim 1, wherein the one or more internals comprise two or more internals.

11. The system of claim 10, wherein the two or more internals are located in a dense phase zone of the fluidized bed reactor.

12. The system of claim 11, wherein the two or more internals are evenly spaced.

13. The system of claim 1, wherein the one or more internals comprise angled channels.

14. The system of claim 1, wherein the one or more internals are configured to promote downward flow of solid particles down the fluidized bed reactor.

15. The system of claim 1, wherein the one or more internals are arranged to achieve residence time distribution and a mean residence time for solid particles that yields the Li2S having a purity >95 wt %.

16. A method of forming Li2S comprising:
providing a fluidized bed reactor comprising one or more internals;
continuously feeding anhydrous lithium hydroxide (LiOH) to the fluidized bed reactor;
continuously feeding a hydrogen sulfide (H2S) gas to the fluidized bed reactor; and
contacting the LiOH with the H2S to produce lithium sulfide (Li2S) while flowing the LiOH downward the fluidized bed reactor through the one or more internals.

17. The method of claim 16, further comprising feeding the Li2S to a side stripper fluidly coupled to or integrated in the fluidized bed reactor.

18. The method of claim 17, further comprising stripping excess H2S, moisture, or both from the bottom effluent stream to yield a stripped Li2S product stream and a stripper gas effluent.

19. The method of claim 18, further comprising recycling the dried H2S stripper gas effluent stream to the fluidized bed reactor.

20. The method of claim 16, further comprising filtering an overhead gas stream of the fluidized bed reactor to separate fines from the overhead gas stream to yield a filtered gas stream.

21. The method of claim 20, recycling the fines separated from the overhead gas stream to the fluidized bed reactor.

22. The method of claim 21, recycling the filtered gas stream to the fluidized bed reactor.

23. The method of claim 16, wherein the Li2S produced has a purity >95 wt %.
